(19) United States
(12) Patent Application Publication
(10) Pub. No.: US 2022/0172196 A1
(43) Pub. Date: Jun. 2, 2022

(54) ELECTRONIC MONEY EXCHANGING APPARATUS, ELECTRONIC MONEY EXCHANGING METHOD, AND ELECTRONIC MONEY EXCHANGING SYSTEM

(71) Applicant: Kenichi KANEKO, Tokyo (JP)

(72) Inventor: Hiroyuki KOMACHI, Tokyo (JP)

(21) Appl. No.: 17/672,703

(22) Filed: Feb. 16, 2022

Related U.S. Application Data
(63) Continuation of application No. PCT/JP2020/015472, filed on Apr. 6, 2020.

(30) Foreign Application Priority Data
Aug. 26, 2019 (JP) 2019-153765

(51) Int. Cl. G06Q 20/38; G06Q 20/06

(52) U.S. Cl. CPC G06Q 20/381; G06Q 20/065

(57) ABSTRACT

A point exchange apparatus includes a storage unit storing electronic money information for identifying electronic money available for each of a plurality of users, an information acquisition unit acquiring exchange conditions from an information terminal used by a first user, an exchange quantity determination unit that determines a first release quantity of first electronic money the first user exchanges for second electronic money and a second acquisition quantity acquired by the first user among the second electronic money available for the second user, and an exchange processing unit that executes an exchange process in which the second acquisition quantity of second electronic money is stored in the storage unit as usable electronic money in association with the first user and the first release quantity of first electronic money is stored in the storage unit as usable electronic money in association with a user who is different from the first user.

### CROSS-REFERENCE TO RELATED APPLICATIONS

The present application is a continuation application of International Application number PCT/JP2020/015472, filed on Apr. 6, 2020, which claims priority under 35 U.S.C §119(a) to Japanese Patent Application No. 2019-153765, filed on Aug. 26, 2019. The contents of these applications are incorporated herein by reference in their entirety.

### BACKGROUND

The present disclosure relates to an electronic money exchange apparatus, an electronic money exchange method, and an electronic money exchange system for exchanging electronic money.

Conventionally, a point exchange system is known in which a user to whom points are given exchanges the points he/she owns for other points (for example, see Japanese Unexamined Patent Application Publication No. 2005-4621).

In a conventional point exchange system, a point exchange is realized by transferring points to be exchanged from an exchange source issuer, who issues points which a user owns, to an exchange destination issuer, who issues points which the user desires to acquire. In this case, the number of points issued by the exchange source issuer would decrease, and this has resulted in a problem of causing a disadvantage to the exchange source issuer whose number of issued points was decreased.

### SUMMARY

The present disclosure focuses on this point and its object is to provide an electronic money exchange apparatus, an electronic money exchange method, and an electronic money exchange system that enable exchange of electronic money without affecting the quantity of electronic money issued by an issuer of electronic money such as points.

An electronic money exchange apparatus according to a first aspect of the present disclosure includes: a storage unit that stores electronic money information for identifying electronic money available for each of a plurality of users; an information acquisition unit that acquires exchange conditions from an information terminal which is used by a first user who desires to exchange first electronic money for second electronic money; an exchange quantity determination unit that determines, on the basis of the exchange conditions and the electronic money information, a first release quantity which is the quantity of first electronic money the first user exchanges for the second electronic money and a second acquisition quantity which is the quantity of second electronic money acquired by the first user from among the second electronic money available for a second user, who is someone other than the first user; and an exchange processing unit that executes an exchange process in which the second acquisition quantity of second electronic money is stored in the storage unit as usable electronic money in association with the first user, and the first release quantity of first electronic money is stored in the storage unit as the usable electronic money in association with a user who is different from the first user and has acquired the first electronic money released by the first user.

An electronic money exchange method according to a second aspect of the present disclosure includes the steps of: acquiring an exchange condition from an information terminal which is used by a first user who desires to exchange first electronic money for second electronic money; determining, on the basis of electronic money information for identifying electronic money available for each of a plurality of users stored in a storage unit, a first release quantity which is the quantity of first electronic money the first user exchanges for the second electronic money and a second acquisition quantity which is the quantity of second electronic money acquired by the first user from among the second electronic money available for a second user, who is someone other than the first user; storing the second acquisition quantity of second electronic money in the storage unit as usable electronic money in association with the first user; and storing the first release quantity of first electronic money in the storage unit as the usable electronic money in association with a user who is different from the first user and has acquired the first electronic money released by the first user, that are executed by a computer.

An electronic money exchange system according to a third aspect of the present disclosure includes: an electronic money exchange apparatus that exchanges electronic money owned by a plurality of users; and a plurality of information terminals used by the plurality of users. The electronic money exchange apparatus includes: a storage unit that stores electronic money information for identifying electronic money available for each of the plurality of users; an information acquisition unit that acquires exchange conditions from one of the information terminals used by a first user who desires to exchange first electronic money for second electronic money; and an exchange quantity determination unit that determines, on the basis of the exchange conditions and the electronic money information, a first release quantity which is the quantity of first electronic money the first user exchanges for the second electronic money and a second acquisition quantity which is the quantity of second electronic money acquired by the first user from among the second electronic money available for a second user, who is someone other than the first user; and an exchange processing unit that executes an exchange process in which the second acquisition quantity of second electronic money is stored in the storage unit as usable electronic money in association with the first user, and the first release quantity of first electronic money is stored in the storage unit as the usable electronic money in association with a user who is different from the first user and has acquired the first electronic money released by the first user.

### BRIEF DESCRIPTION OF THE DRAWINGS

FIG. 1 illustrates an outline of an electronic money exchange system S.

FIG. 2 illustrates an outline of the electronic money exchange system S.

FIG. 3 illustrates an outline of the electronic money exchange system S.

FIG. 4 illustrates an outline of the electronic money exchange system S.

FIG. 5 shows a configuration of a point exchange apparatus 1.

FIG. 6A shows an example of a point management database.

FIG. 6B shows an example of a point management database.

FIG. 7 shows a configuration of an information terminal 2.

FIG. 8 shows an example of an operation sequence of the electronic money exchange system S.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### [Outline of an Electronic Money Exchange System S]

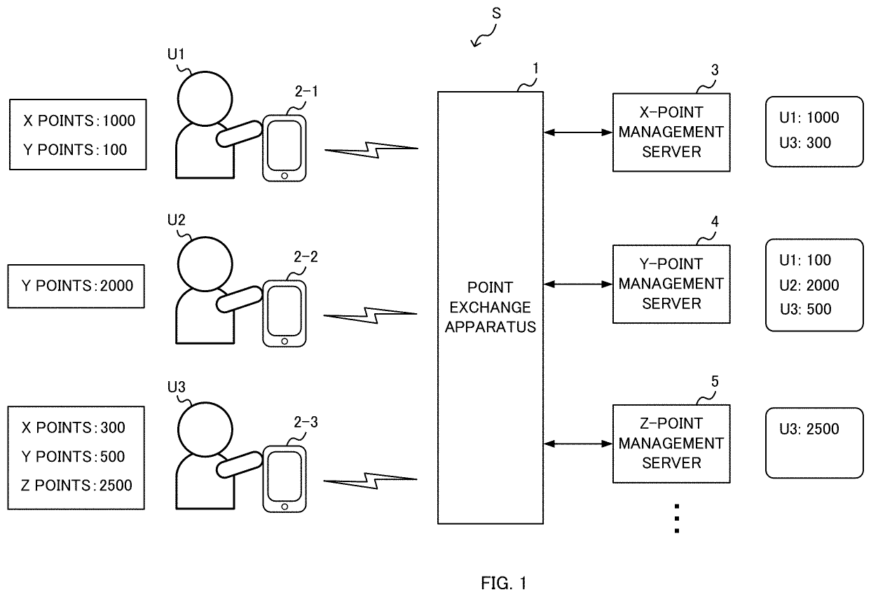

FIGS. 1 to 4 each illustrate an outline of an electronic money exchange system S. The electronic money exchange system S is a system for exchanging electronic money. The electronic money is a payment means using an information and communication technology provided by a company, and is points, a token, or a prepaid-type currency, for example. In the present embodiment, a case where the electronic money is points is exemplified, but the present embodiment can also be applied to electronic money other than the points.

The electronic money exchange system S includes a point exchange apparatus 1, a plurality of information terminals 2 (information terminals 2-1 to 2-3 in FIGS. 1 to 4), an X-point management server 3, a Y-point management server 4, and a Z-point management server 5. The point exchange apparatus 1 is an example of an electronic money exchange apparatus, and is a computer for supporting the mutual exchange of points owned by a plurality of users U (a first user U1 to a third user U3 in FIGS. 1 to 4). The point exchange apparatus 1 temporarily holds on to the points owned by the plurality of users U, and provides the users U points that each of the plurality of users U desires to use in place of the points owned by each of the plurality of users U. The “temporarily holds on to the points” means storing the type and the number of points deposited by the users U in association with the users U who desire to deposit their points. Details will be described later.

The information terminal 2 is a computer each of the plurality of users U uses, and is a smartphone, a tablet, or a personal computer, for example. In an example shown in FIG. 1, the first user U1 uses an information terminal 2-1, the second user U2 uses an information terminal 2-2, and the third user U3 uses an information terminal 2-3. The information terminal 2 can transmit and receive data to and from the point exchange apparatus 1 via the Internet, for example.

The information terminal 2 can execute point exchange application software (hereinafter referred to as “point exchange app”) that executes processing for exchanging points by accessing the point exchange apparatus 1. A case where the point exchange app is installed in the information terminal 2 is exemplified in the present embodiment, but the information terminal 2 may execute the point management app in the form of a web app which is available through the Internet.

A user U can register the points he/she owns in the point exchange apparatus 1 and exchange some or all of his/her points for other types of points using the point exchange app executed by the information terminal 2. The user U may register only the points he/she desires to exchange in the point exchange apparatus 1, or may register all of the points he/she owns in the point exchange apparatus 1 and specify, from among the registered points, the type and the number of points he/she desires to exchange for other points. By using the point exchange app or other application software, the user U can use, in a store or the like, the points registered in the point exchange apparatus 1 and the points acquired due to the exchange.

The X-point management server 3, the Y-point management server 4, and the Z-point management server 5 are servers for a business operator, who issues points, to manage the points. In the example shown in FIG. 1, the X-point management server 3 manages the number of owned X points in association with a plurality of users U. The X-point management server 3 reads user identification information stored in a point card or the information terminal 2 with a point card reader installed in a store, and increases the users U's X points when the X points are given to the users U, or decreases the users U's X points when they use the X points. The X-point management server 3 also increases and decreases the users U's X points upon being notified of (i) the user identification information and (ii) the number of given or used X points from the point exchange apparatus 1.

The Y-point management server 4 manages the number of owned Y points in association with a plurality of users U. The Z-point management server 5 manages the number of owned Z points in association with a plurality of users U. In a similar manner as with the X-point management server 3, the Y-point management server 4 and the Z-point management server 5 read user identification information stored in a point card or the information terminal 2 with a point card reader installed in a store, thereby increasing the users U's Y points or Z points or decreasing their Y points or Z points. Further, the Y-point management server 4 and the Z-point management server 5 also increase or decrease the users U's Y points or Z points upon being notified of (i) the user identification information and (ii) the number of given or used Y points or the number of given or used Z points from the point exchange apparatus 1.

Hereinafter, an outline of a process in which the point exchange apparatus 1 exchanges the points owned by the plurality of users U will be described while referencing FIGS. 1 to 4. FIGS. 1 to 4 show only the first user U1, the second user U2, and the third user U3 as an example, but the point exchange apparatus 1 may exchange points owned by more users U.

Here, a case where the first user U1 desires to exchange his/her X points for Y points, the second user U2 desires to exchange his/her Y points for Z points, and the third user U3 desires to exchange his/her Z points for X points will be illustrated as an example.

FIG. 1 shows a state before the first user U1, the second user U2, and the third user U3 register their points in the point exchange apparatus 1. The first user U1 owns 1000 X points and 100 Y points. The second user U2 owns 2000 Y points. The third user U3 owns 300 X points, 500 Y points, and 2500 Z points.

The X-point management server 3 stores that the first user U1 owns 1000 points and the third user U3 owns 300 points. The Y-point management server 4 stores that the first user U1 owns 100 points, the second user U2 owns 2000 points, and the third user U3 owns 500 points. The Z-point management server 5 stores that the third user U3 owns 2500 points.

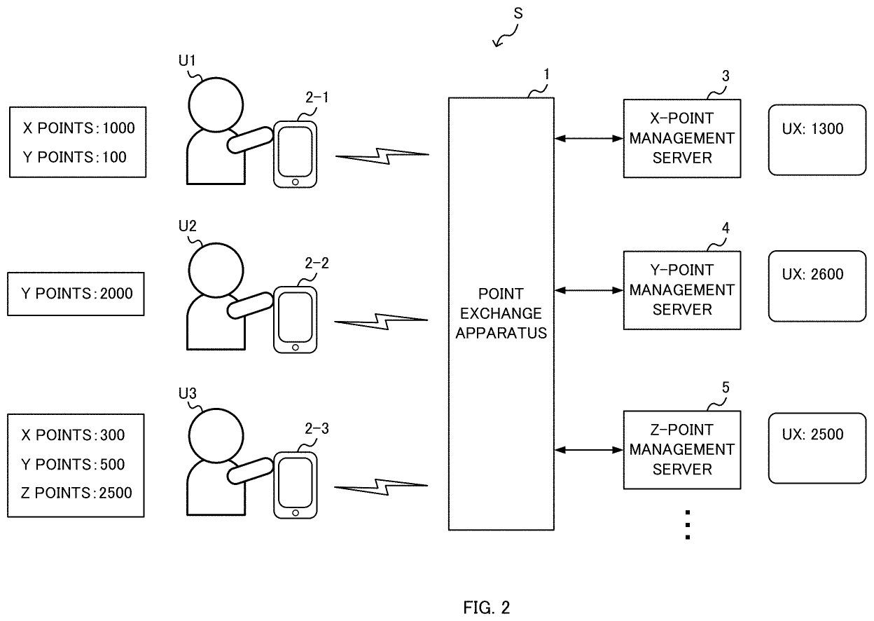

FIG. 2 shows a state in which the first user U1, the second user U2, and the third user U3 registered their points in the point exchange apparatus 1. In FIG. 2, a case where the first user U1, the second user U2, and the third user U3 registered all of their points in the point exchange apparatus 1 is illustrated as an example, but the first user U1, the second user U2, and the third user U3 may register only some of their points (for example, the points they desire to exchange) in the point exchange apparatus 1.

When a user U registers points in the point exchange apparatus 1, the point exchange apparatus 1 provides notification that the user U used the points and a management user UX, who is a predetermined management user, has acquired the points to the point management servers (the X-point management server 3, the Y-point management server 4, and the Z-point management server 5) that manage the balance of points in association with the user U. The point exchange apparatus 1 transmits and receives data for notifying about the number of used points and the number of acquired points by using application programming interface (API) for transmitting and receiving data to and from the point management servers, for example. The management user UX is an administrator of the point exchange apparatus 1, for example. The management user UX does not need to be a real user and may be a fictitious user.

In an example shown in FIG. 2, the X-point management server 3 stores that the management user UX owns 1300 X points, the Y-point management server 4 stores that the management user UX owns 2600 Y points, and the Z-point management server 5 stores that the management user UX owns 2500 Z points. That is, in this state, the management user UX can use 1300 X points, 2600 Y points, and 2500 Z points.

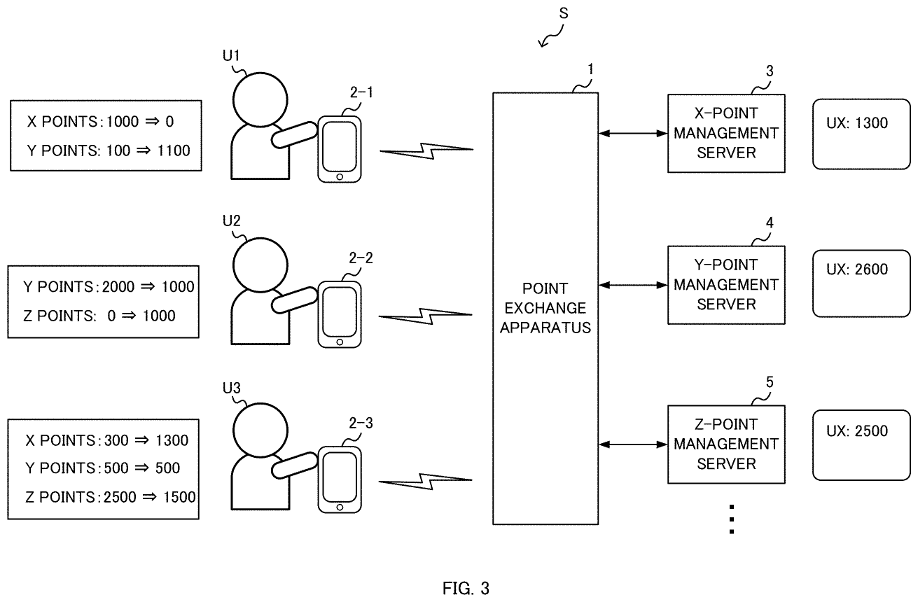

FIG. 3 shows a state after the point exchange apparatus 1 exchanged the points owned by the first user U1, the second user U2, and the third user U3. The point exchange apparatus 1 gives 1000 Y points, which are equivalent to 1000 X points provided by the first user U1, among the Y points acquired from the second user U2 to the first user U1 who desires to exchange his/her X points for Y points.

The point exchange apparatus 1 gives 1000 Z points, which are equivalent to 1000 Y points that the second user U2 set to exchange, among the Z points acquired from the third user U3 to the second user U2 who desires to exchange his/her Y points for Z points. The point exchange apparatus 1 gives 1000 X points, which are equivalent to 1000 Z points acquired from the third user U3, to the third user U3 who desires to exchange his/her Z points for X points.

In this manner, the point exchange apparatus 1 exchanges the points owned by the first user U1, the second user U2, and the third user U3 who desire to exchange their points. After having exchanged the points, the point exchange apparatus 1 provides notification about an exchange result to the information terminals 2 that execute the point exchange app. That is, the point exchange apparatus 1 notifies the information terminals 2 of the type and the number of points that the users U can use by using the information terminals 2 that execute the point exchange app.

Upon receiving a notification of the exchange result of the points, the information terminals 2 operate so that the points can be used up to the notified number of points. As shown in FIG. 3, the owner of the points is the management user UX in the X-point management server 3, the Y-point management server 4, and the Z-point management server 5 even after the points were exchanged in the point exchange apparatus 1. However, by using predetermined application software (for example, an exchange app) in the information terminals 2, the first user U1, the second user U2, and the third user U3 can use the number of points the management user UX owns in a store or the like.

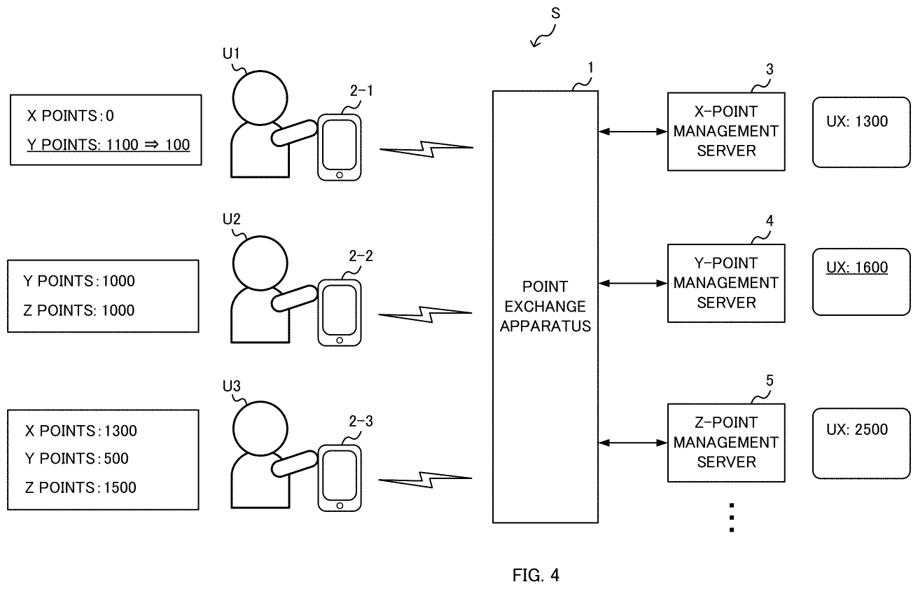

FIG. 4 shows a state after the first user U1 used 1000 Y points. When the first user U1 has used 1000 Y points, the number of Y points available for the management user UX stored in the Y-point management server 4 is decreased from 2600 to 1600. Further, the number of Y points available for the first user U1 is decreased from 1100 to 100.

As described above, by using the electronic money exchange system S, the users U can exchange the points they own for other type of points, and can use the exchanged points by using the information terminals 2. Such an electronic money exchange system S is suitable when the type of points a user U owns is different from the type of points the user U can use. For example, when the user U goes to a region where only specific points can be used, since he/she can exchange his/her points for points that are usable in that destination region, it makes it easier for the user U to use his/her points practically.

In the above description, a case where a value per point of all points is the same was illustrated as an example, but the value per point of a plurality of points may be different. In this case, 1000 X points may be exchanged for the number of Y points different from 1000, for example.

### [Configuration of the Point Exchange Apparatus 1]

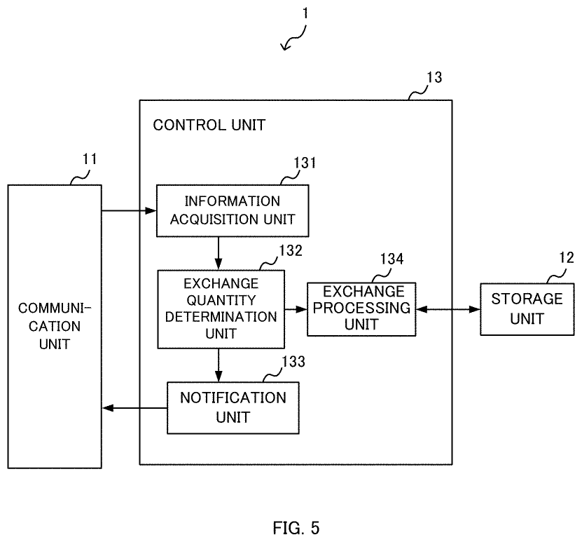

FIG. 5 shows a configuration of the point exchange apparatus 1. The point exchange apparatus 1 includes a communication unit 11, a storage unit 12, and a control unit 13. The control unit 13 includes an information acquisition unit 131, an exchange quantity determination unit 132, a notification unit 133, and an exchange processing unit 134.

The communication unit 11 includes a communication interface for transmitting and receiving data to and from the information terminals 2 or the X-point management server 3. The communication unit 11 includes a communication controller for accessing a network, for example.

The storage unit 12 includes a storage medium such as a read only memory (ROM), a random access memory (RAM), a hard disk, and the like. The storage unit 12 stores a program executed by the control unit 13. Further, the storage unit 12 stores electronic money information for identifying points, which are electronic money owned by each of the plurality of users U, in association with each of the plurality of users U. Specifically, the storage unit 12 stores a point management database including data of the type and the number of points owned by the users U. Information indicating the type and the number of points included in the point management database is an example of the electronic money information.

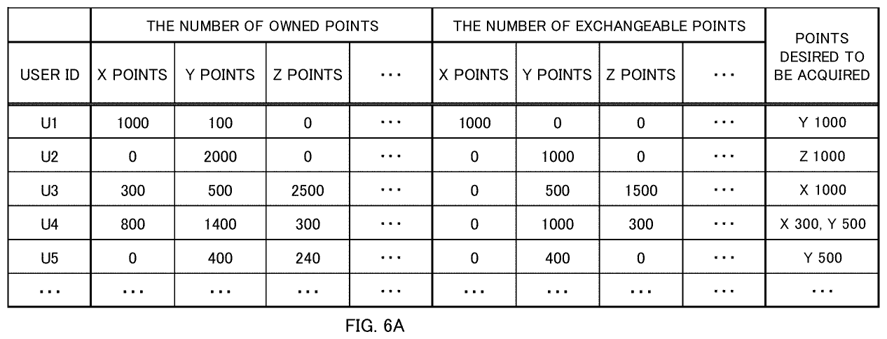

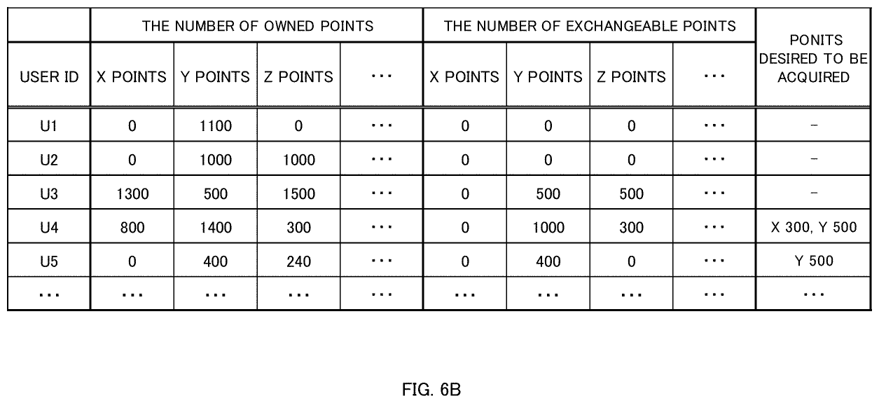

FIGS. 6A and 6B each show an example of the point management database. In the point management database, (i) user IDs for identifying the users U, (ii) the number of points for each of the plurality of points owned by the users U, and (iii) the number of exchangeable points for each of the plurality of points owned by the users U are associated with each other. Further, in the point management database, the type and the number of points the users U desire to acquire are associated with the user IDs.

FIG. 6A corresponds to the state shown in FIG. 2, and shows the number of owned points and the number of exchangeable points before points are exchanged among the first user U1, the second user U2, and the third user U3. In FIG. 6A, points of many users U, such as a user U4, a user U5, and the like that are not shown in FIG. 2 are also shown. In an example shown in FIG. 6A, the first user U1 indicates that his/her 1000 X points are exchangeable. The second user U2 indicates that 1000 points out of his/her 2000 Y points are exchangeable. The third user U3 indicates that his/her 500 Y points and 1500 points out of his/her 2500 Z points are exchangeable.

FIG. 6B corresponds to the state shown in FIG. 3, and shows a state after a point exchange among the first user U1, the second user U2, and the third user U3 is completed. The X points owned by the first user U1 have decreased from 1000 points to 0 points, but his/her Y points have increased from 100 points to 1100 points, compared to FIG. 6A. The Y points owned by the second user U2 have decreased from 2000 points to 1000 points, but his/her Z points have increased from 0 points to 1000 points. The Z points owned by the third user U3 have decreased from 2500 points to 1500 points, but his/her X points have increased from 300 points to 1300 points. In addition, the number of exchangeable points of the first user U1, the second user U2, and the third user U3 has also decreased.

The control unit 13 is a central processing unit (CPU), for example. The control unit 13 functions as an information acquisition unit 131, an exchange quantity determination unit 132, a notification unit 133, and an exchange processing unit 134 by executing a program stored in the storage unit 12.

The information acquisition unit 131 acquires, from the information terminals 2 which the plurality of users U use, information indicating the type and the number of points that the plurality of users U desire to register. Further, the information acquisition unit 131 acquires, from the information terminals 2 which the plurality of users U use, requests that the users U desire to exchange first electronic money (e.g., X points) registered by the users U for second electronic money (e.g., Y points). Further, the information acquisition unit 131 acquires exchange conditions from the first user U1 who desires to exchange the first electronic money for the second electronic money. The exchange conditions are the number of X points that the first user U1 desires to release, the number of Y points that the first user U1 desires to acquire, an exchange rate at the time of exchange (the ratio of the number of points before the exchange to the number of points after the exchange), and the like, for example.

The information acquisition unit 131 further acquires exchange conditions from the second user U2 who desires to exchange the second electronic money (e.g., Y points) for third electronic money (e.g., Z points). The exchange conditions are the number of Y points the second user U2 desires to release, the number of Z points the second user U2 desires to acquire, an exchange rate at the time of exchange, and the like, for example. In the example described with reference to FIGS. 1 to 4, the information acquisition unit 131 further acquires exchange conditions from the third user U3 who desires to exchange the third electronic money for the first electronic money. The exchange conditions are the number of Z points the third user U3 desires to release, the number of X points the third user U3 desires to acquire, an exchange rate at the time of exchange, and the like, for example. The timing at which the information acquisition unit 131 acquires these exchange conditions can be any timing.

The information acquisition unit 131 notifies the exchange quantity determination unit 132 of the acquired exchange conditions. The information acquisition unit 131 may store the acquired exchange conditions in the storage unit 12 in association with the users U who specified the exchange conditions, and notify the exchange quantity determination unit 132 of the exchange conditions via the storage unit 12.

The exchange quantity determination unit 132 determines, on the basis of the exchange conditions specified by the users U and the electronic money information stored in the point management database, a first release quantity which is the quantity of first electronic money the first user U1 exchanges for the second electronic money, and a second acquisition quantity which is the quantity of second electronic money acquired by the first user U1 from among the second electronic money available for a user U (e.g., the second user U2) other than the first user U1. The second electronic money available for the second user U2 is the second electronic money that is stored in the storage unit 12 as electronic money that can be used by the second user U2. In the example described with reference to FIGS. 1 to 4, the first release quantity is 1000 points, and the second acquisition quantity is 1000 points. The exchange quantity determination unit 132 notifies the notification unit 133 and the exchange processing unit 134 of the determined first release quantity and the determined second acquisition quantity.

Similarly, on the basis of the exchange conditions notified from the information acquisition unit 131, the exchange quantity determination unit 132 determines a second release quantity which is the quantity of second electronic money the second user U2 exchanges for the third electronic money, and a third acquisition quantity which is the quantity of third electronic money acquired by the second user U2 from among the third electronic money available for a user U other than the second user U2. In the example described with reference to FIGS. 1 to 4, the second release quantity is 1000 points and the third acquisition quantity is 1000 points. The exchange quantity determination unit 132 notifies the notification unit 133 and the exchange processing unit 134 of the determined second release quantity and the determined third acquisition quantity.

Similarly, on the basis of the exchange conditions provided as notification from the information acquisition unit 131, the exchange quantity determination unit 132 determines a third release quantity which is the quantity of third electronic money the third user U3 exchanges for the first electronic money, and a first acquisition quantity which is the quantity of first electronic money acquired by the third user U3 from among the first electronic money available for a user U other than the third user U3. In the example described with reference to FIGS. 1 to 4, the third release quantity is 1000 points, and the first acquisition quantity is 1000 points. The exchange quantity determination unit 132 notifies the notification unit 133 and the exchange processing unit 134 of the determined third release quantity and the determined first acquisition quantity.

The notification unit 133 notifies an electronic money management server which manages electronic money that the electronic money is used or that the electronic money is acquired. That is, in a similar manner as with the point card reader or the like installed in a store or the like, the notification unit 133 uses the API for transmitting and receiving data to and from the point management servers to notify the electronic money management server about an increase and decrease of electronic money.

For example, on a condition that the first user U1 can exchange the first electronic money for the second electronic money, the notification unit 133 notifies the X-point management server 3 that the first user U1 used the first release quantity of first electronic money. More specifically, on a condition that the exchangeable second electronic money of the second acquisition quantity or more is stored in the storage unit 12, the notification unit 133 notifies the X-point management server 3 which manages the first electronic money that the first user U1 used the first release quantity of first electronic money.

On a condition that the exchangeable second electronic money of the second acquisition quantity or more is stored in the storage unit 12 in association with the management user UX, the notification unit 133 may notify the X-point management server 3 which manages the first electronic money that the first user U1 used the first release quantity of first electronic money. Since the notification unit 133 operates in this manner, it is possible to prevent the first electronic money owned by the first user U1 from decreasing, despite that the first user U1 being unable to exchange the first electronic money for the desired electronic money.

Further, there is a case where exchange processing desired by the first user U1 is established by exchanging electronic money among three or more users U, as in the example shown in FIGS. 1 to 4. In such a case, on a condition that the exchange of the first electronic money, the second electronic money, and the third electronic money will be established among three or more users U, the notification unit 133 notifies the X-point management server 3, the Y-point management server 4, and the Z-point management server 5, which respectively manage the first electronic money, the second electronic money, and the third electronic money, that the first electronic money, the second electronic money, and the third electronic money owned by the three or more users U were used.

For example, the notification unit 133 notifies the X-point management server 3 which manages the first electronic money that the name of the first electronic money owned by the first user U1 was changed to the management user UX, who is a predetermined management user. Specifically, the notification unit 133 notifies the X-point management server 3 managing the X points, which is the first electronic money, that the first user U1 used the first release quantity of first electronic money, and that the management user UX who is the predetermined management user has acquired the first release quantity of first electronic money. More specifically, in the example described with reference to FIGS. 1 to 4, the notification unit 133 notifies the X-point management server 3 that the first user U1 used 1000 X points, and that the management user UX has acquired 1000 X points.

Similarly, the notification unit 133 notifies the Y-point management server 4 managing the Y points, which is the second electronic money, that the second user U2 used the second release quantity of second electronic money, and that the management user UX has acquired the second release quantity of second electronic money. Specifically, in the example described with reference to FIGS. 1 to 4, the notification unit 133 notifies the Y-point management server 4 that the second user U2 used 1000 Y points, and that the management user UX has acquired 1000 Y points.

Similarly, the notification unit 133 notifies the Z-point management server 5 managing the Z points, which is the third electronic money, that the third user U3 used the third release quantity of third electronic money, and that the management user UX has acquired the third release quantity of third electronic money. Specifically, in the example described with reference to FIGS. 1 to 4, the notification unit 133 notifies the Z-point management server 5 that the third user U3 used 1000 Z points, and that the management user UX has acquired 1000 Z points.

It should be noted that the notification unit 133 may notify the point management servers that the user U used the registered electronic money, and that the registered electronic money is acquired by the management user UX, at a point in time when the user U has registered the owned electronic money in the point exchange apparatus 1.

The exchange processing unit 134 exchanges points owned by the plurality of users U, and executes exchange processing in which the point management database is updated on the basis of the number of points of each user U after the exchange. The exchange processing unit 134 updates the point management database by storing, as electronic money owned by the first user U1, the second acquisition quantity of second electronic money (e.g., Y points) determined by the exchange quantity determination unit 132 in association with the first user U1 in the storage unit 12, for example. Further, the exchange processing unit 134 updates the point management database by storing the first release quantity of first electronic money in the storage unit 12 in association with a user U (the third user U3 in the above-described example) who is different from the first user U1 and has acquired the first electronic money released by the first user U1.

The exchange processing unit 134 executes exchange processing on a condition that the second electronic money, which the electronic money information indicates as exchangeable among the second electronic money available for the second user U2, is equal to or more than the second acquisition quantity. The exchange processing unit 134 may execute exchange processing on a condition that consent for the exchange is obtained from the second user U2. Since the exchange processing unit 134 operates in this manner, the user U can register both electronic money that may be exchanged and electronic money that cannot be exchanged in the point exchange apparatus 1.

After executing exchange processing, the exchange processing unit 134 may notify the information terminal 2 used by each user U of the quantity of electronic money each user U owns after the exchange. For example, the exchange processing unit 134 sends, as a push notification, a message including the number of owned X points, the number of owned Y points, and the number of owned Z points to the information terminal 2. The exchange processing unit 134 may notify the information terminal 2 of the number of points owned by the user U in response to the information terminal 2 accessing a predetermined URL.

### [Configuration of the Information Terminal 2]

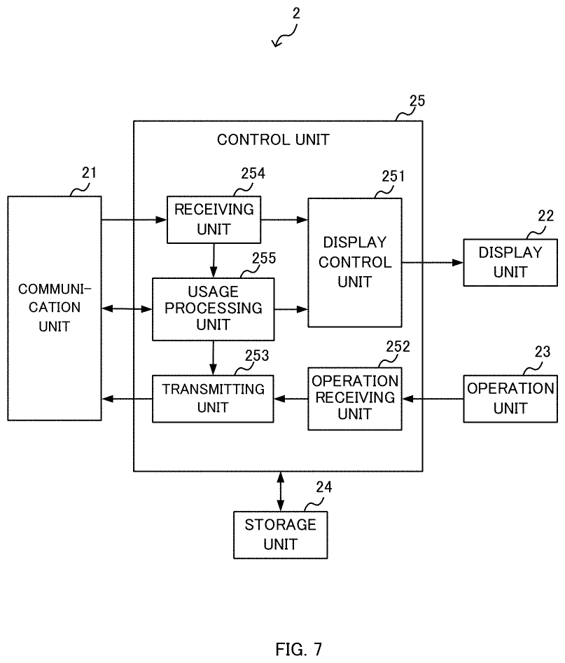

FIG. 7 shows a configuration of the information terminal 2. The information terminal 2 includes a communication unit 21, a display unit 22, an operation unit 23, a storage unit 24, and a control unit 25. The control unit 25 includes a display control unit 251, an operation receiving unit 252, a transmitting unit 253, a receiving unit 254, and a usage processing unit 255.

The communication unit 21 has a communication interface for transmitting and receiving data to and from the point exchange apparatus 1. The communication unit 21 has a wireless communication controller for accessing a wireless communication line, for example. The communication unit 21 may include a wireless communication controller for transmitting and receiving information to and from an external device such as a point card reader installed in a store.

The display unit 22 is a display for displaying various types of information. The operation unit 23 is an operation device used by the user U to operate the information terminal 2 and input various types of information, and is a touch panel provided on the display unit 22, for example.

The storage unit 24 includes a storage medium such as a ROM, a RAM, and the like. The storage unit 24 stores various types of application software (programs) executed by the control unit 25. The storage unit 24 stores a point exchange app for a user U who uses the information terminal 2 to register his/her points in the point exchange apparatus 1 and notify the point exchange apparatus 1 of the type and the number of points he/she desires to exchange, for example.

The control unit 25 includes a CPU, for example. The control unit 25 functions as the display control unit 251, the operation receiving unit 252, the transmitting unit 253, the receiving unit 254, and the usage processing unit 255 by executing the program stored in the storage unit 24.

The display control unit 251 causes the display unit 22 to display various types of information. The display control unit 251 displays a point registration screen for registering the user U's points in the point exchange apparatus 1, a point balance confirmation screen indicating the type and the number of points registered by the user U in the point exchange apparatus 1, and a point exchange screen for exchanging the user U's points for other types of points, for example. Further, the display control unit 251 displays a point use screen for the user U to use the points registered in the point exchange apparatus 1.

The operation receiving unit 252 identifies input information and various operation contents performed in the operation unit 23, and notifies another processing unit about the specified operation contents or input information. The operation receiving unit 252 specifies the point type and the number of points input in a state where the point registration screen is displayed on the display unit 22, and notifies the transmitting unit 253 of the acquired information. Further, the operation receiving unit 252 specifies (i) the point type and the number of points to be exchanged, which are input in a state where the point exchange screen is displayed on the display unit 22, and (ii) an operation of instructing exchange processing, and then notifies the transmitting unit 253 of the specified contents, for example. Further, the operation receiving unit 252 specifies an instruction to use points input in a state where the point use screen is displayed on the display unit 22.

The transmitting unit 253 transmits various types of information to an external device (for example, the point exchange apparatus 1 or a terminal installed in a store). The transmitting unit 253 transmits the point type and the number of points input on the point registration screen to the point exchange apparatus 1, for example. Further, when receiving an instruction for exchange processing from the operation receiving unit 252, the transmitting unit 253 transmits information indicating (i) the point type and the number of points to be exchanged and (ii) a request for exchange processing to the point exchange apparatus 1, for example.

When the instruction to use the points registered in the point exchange apparatus 1 is carried out in a state where the point use screen is displayed on the display unit 22, the transmitting unit 253 transmits identification information of the management user UX, and the type and the number of points to be used to the point card reader on the basis of the instruction of the use processing unit 255. Further, the transmitting unit 253 transmits information indicating the type and the number of used points to the point exchange apparatus 1. For example, when the first user U1 uses the Y points, which is the second electronic money, the transmitting unit 253 of the information terminal 2 which is used by the first user U1 notifies the point exchange apparatus 1 that the Y points were used.

The receiving unit 254 receives various types of information from the point exchange apparatus 1. For example, after the user U has performed an operation of registering his/her points, the receiving unit 254 receives, from the point exchange apparatus 1, information indicating the point type and the number of points for which registration has been completed. Further, the receiving unit 254 receives a notification from the point exchange apparatus 1 that exchange processing is completed after the user U has performed an operation of exchanging the points. The receiving unit 254 notifies the display control unit 251 of the received contents, thereby displaying the contents on the display unit 22.

The usage processing unit 255 executes processing in which the user U uses electronic money. For example, when the first user U1 uses the Y points as the second electronic money, the use processing unit 255 of the information terminal 2, which the first user U1 uses, transmits information for using the Y points in the account name of the management user UX to the point card reader of the store via the transmitting unit 253 and the communication unit 21. When the use of the electronic money is approved by the point card reader, the use processing unit 255 notifies the point exchange apparatus 1 of the type and the quantity of electronic money used, via the transmitting unit 253. Since the usage processing unit 255 operates in this manner, the users U can use the electronic money even if the electronic money is registered in the name of the management user UX in the point management servers.

### [Operation Sequence]

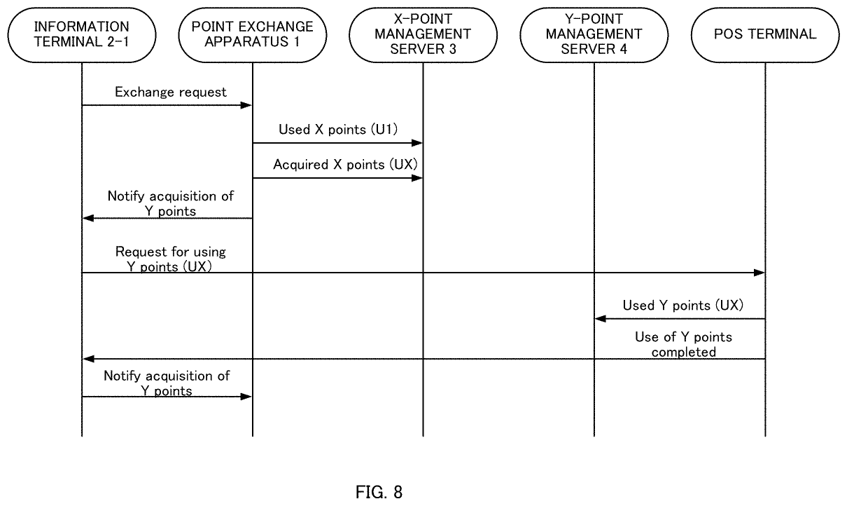

FIG. 8 shows an example of an operation sequence of the electronic money exchange system S. FIG. 8 shows an operation when the first user U1 exchanges his/her X points for Y points.

When the first user U1 performs an operation for exchanging 1000 X points for 1000 Y points in the communication unit 21, the communication unit 21 notifies the point exchange apparatus 1 of an exchange request for requesting to exchange 1000 X points for 1000 Y points.

The point exchange apparatus 1 searches for a method of exchanging 1000 X points for 1000 Y points. As in the example shown in FIGS. 1 to 4, when the point exchange apparatus 1 can exchange 1000 Y points, the point exchange apparatus 1 notifies the X-point management server 3 that the first user U1 used 1000 X points and that the management user UX has acquired 1000 X points. Then, the point exchange apparatus 1 notifies the communication unit 21 that the Y points have been acquired in place of the X points released by the first user U1.

Thereafter, it is assumed that in order to use his/her 500 Y points, the first user U1 started up application software for using points in the information terminal 2-1. The information terminal 2-1 transmits a request for using the 500 Y points to a point card reader of a store which uses the Y points. At this time, the information terminal 2-1 transmits the request to use the Y points together with the identification information of the management user UX.

Upon receiving the request to use the Y points, the point card reader notifies the Y-point management server 4 that the management user UX used 500 Y points, for example. Further, the point card reader notifies the information terminal 2-1 that the use of 500 Y points has been completed. When the information terminal 2-1 receives the notification, the information terminal 2-1 notifies the point exchange apparatus 1 that 500 Y points were used.

### First Variation Example

Even if a user U desires to exchange his/her electronic money for other electronic money, the user U may not desire to exchange his/her electronic money when the exchange rate is poor. Therefore, the point exchange apparatus 1 may determine whether or not to carry out an exchange on the basis of a range of exchange rates allowable by each of the users U. The exchange rate is a ratio of the second acquisition quantity to the first release quantity when the first electronic money is exchanged for the second electronic money.

In this case, the information acquisition unit 131 acquires (i) a first range which is a range of exchange rates allowable by the first user U1 when he/she exchanges the first electronic money for the second electronic money, and (ii) a second range which is a range of exchange rates allowable by the second user U2 when he/she exchanges the second electronic money for the first electronic money. Then, the exchange quantity determination unit 132 determines the second acquisition quantity on the basis of an exchange rate included in the first range and the second range. The exchange quantity determination unit 132 determines the amount of the exchange on a condition that a predetermined exchange rate is included in both the first range and the second range, for example. Since the point exchange apparatus 1 operates in this manner, the first electronic money and the second electronic money can be exchanged under conditions that both the first user U1 and the second user U2 are satisfied with.

### Second Variation Example

When the expiration date of a user U's electronic money approaches, he/she may want to exchange his/her electronic money for other electronic money even if the conditions are not favorable. When the period until the expiration date is shorter than a predetermined period, the point exchange apparatus 1 may worsen the exchange rate compared to when the period until the expiration date is equal to or longer than the predetermined period.

In this case, the storage unit 12 stores electronic money information including expiration date information indicating the expiration date of the electronic money. Further, the exchange quantity determination unit 132 determines the second acquisition quantity on the basis of the length of the period until the expiration date. Specifically, the shorter the period until the expiration date, the more the exchange quantity determination unit 132 decreases the exchange rate to make the second acquisition quantity smaller. The exchange quantity determination unit 132 may provide notification that there are points whose exchange rate has been lowered due to the time period until the expiration date being less than a threshold, to users U other than the user U who owns such points. By operating the point exchange apparatus 1 in this manner, a probability that the electronic money whose period until the expiration date is short will be exchanged increases, and therefore the electronic money will be used effectively.

Further, the point exchange apparatus 1 may acquire the minimum value of the exchange rate allowable by the first user U1, and execute exchange processing of electronic money on a condition that the exchange rate is equal to or greater than the minimum value. In this case, the information acquisition unit 131 acquires the minimum value of the exchange rate allowable by the first user U1 when he/she exchanges the first electronic money for the second electronic money, and the exchange expiration date, which is a deadline for the first user U1 to exchange the first electronic money for the second electronic money. The exchange processing unit 134 executes exchange processing on a condition that the second acquisition quantity is equal to or greater than the minimum value when there is a predetermined period or more until the exchange expiration date. The exchange processing unit 134 executes exchange processing even if the second acquisition quantity is smaller than the minimum value when the period until the exchange expiration is shorter than the predetermined period.

### Third Variation Example

In the above description, only the electronic money registered in the point exchange apparatus 1 is to be exchanged. However, despite electronic money being constantly registered in the point exchange apparatus 1, there is a case where electronic money is temporarily not registered in the point exchange apparatus 1. It is inconvenient if the electronic money cannot be exchanged in such a case.

Therefore, when the point exchange apparatus 1 determines that there is a high probability that the user U can acquire electronic money in a few days on the basis of the user U's past acquisition history of electronic money, the point exchange apparatus 1 may enable the user U to acquire other electronic money even if he/she does not own any electronic money. In this case, the storage unit 12 stores history information indicating a history of the user U's acquisition of electronic money in association with the user U.

Even when the first user U1 does not own the first electronic money corresponding to the second acquisition quantity, when the exchange processing unit 134 determines that the first electronic money corresponding to the second acquisition quantity can be acquired within a predetermined history confirmation period on the basis of the history information, the exchange processing unit 134 stores the second acquisition quantity of second electronic money as usable electronic money in the storage unit 12 in association with the first user U1. The predetermined history confirmation period may be a period that can be selected by the user U, or may be a predetermined period, for example, one week.

The exchange quantity determination unit 132 may determine the exchange rate on the basis of the length of the history confirmation period. The exchange quantity determination unit 132 lowers the exchange rate for a longer history confirmation period, for example. Since the exchange quantity determination unit 132 operates in this manner, it is possible to reduce a risk that a business operator, who manages the point exchange apparatus 1, suffers a loss caused by the user U not being able to acquire the first electronic money within the predetermined period.

### Fourth Variation Example

In the above description, the user U has to register his/her electronic money in the point exchange apparatus 1 by himself/herself. However, there have been cases where the user U has electronic money that may be exchanged but does not register it in the point exchange apparatus 1 because the processes of registering electronic money in the point exchange apparatus 1 are complicated for the user U.

Therefore, the point exchange apparatus 1 may register the electronic money acquired by the user U in response to receiving a notification that the user U has acquired the electronic money from a server that manages the electronic money, such as the X-point management server 3, the Y-point management server 4, the Z-point management server 5, or the like. In this case, when the exchange processing unit 134 receives a notification from the X-point management server 3 that the first user U1 has acquired the first electronic money, the exchange processing unit 134 stores the quantity of first electronic money acquired by the first user U1 in the storage unit 12 in association with the first user U1, for example. Since the exchange processing unit 134 operates in this manner, an amount of electronic money to be exchanged can be increased without the user U feeling that the process is complicated.

### Fifth Variation Example

In the above description, a case where points are exchanged among three users U was illustrated as an example, but the number of users U among whom electronic money is to be exchanged can be any number: it may be two or four or more. Further, in the above description, a case where the electronic money owned by one user U is given to another user U was illustrated as an example, but the electronic money owned by one user U may be divided and given to a plurality of users U.

Further, in the above description, a case where one user U acquires electronic money owned by another user U was illustrated as an example, but one user U may acquire electronic money owned by a plurality of other users U. In this manner, by combining exchangeable electronic money registered by any number of users U to determine the quantity of electronic money exchanged, the exchange quantity determination unit 132 can exchange electronic money so as to satisfy the desires of many users U.

### Sixth Variation Example

In the above description, a case where the point exchange apparatus 1 registers the exchanged electronic money in the name of the management user UX in the point management servers was illustrated as an example. However, the point exchange apparatus 1 may register, in the point management servers, the exchanged electronic money in the name of a user U who can use the exchanged electronic money.

In this case, the notification unit 133 notifies the X-point management server 3 which manages the first electronic money that the name of the first electronic money owned by the first user U1 was changed to the second user U2, for example. Specifically, the notification unit 133 notifies the X-point management server 3 managing the X point, which is the first electronic money, that the first user U1 used the first release quantity of first electronic money, and that the second user U2 has acquired the first release quantity of first electronic money.

### [Effect of the Electronic Money Exchange System S]

As described above, the point exchange apparatus 1 includes the exchange quantity determination unit 132 that determines, on the basis of the exchange conditions acquired from the first user U1, the first release quantity which is the quantity of first electronic money the first user U1 exchanges for the second electronic money, and the second acquisition quantity which is the quantity of second electronic money acquired by the first user U1 from among the second electronic money available for a user U other than the first user U1. Further, the exchange processing unit 134 executes exchange processing in which (i) the second acquisition quantity of second electronic money is stored in the storage unit 12 as usable electronic money in association with the first user U1 and (ii) the first release quantity of first electronic money is stored in the storage unit 12 in association with a user U who is different from the first user U1 and has acquired the first electronic money released by the first user U1.

Since the point exchange apparatus 1 operates in this manner, the user U who owns the electronic money can exchange his/her electronic money with the electronic money owned by other users U, and can use the obtained electronic money. In this manner, since electronic money can be exchanged among a plurality of users U in the point exchange apparatus 1, electronic money can be exchanged without affecting the quantity of electronic money issued by the issuer of the electronic money.

Further, the notification unit 133 notifies the first electronic money management server (e.g., the X-point management server 3) managing the first electronic money that the first user U1 used the first release quantity of first electronic money and that the management user UX has acquired the first release quantity of first electronic money. Further, the notification unit 133 notifies the second electronic money management server (e.g., the Y-point management server 4) that the management user UX has acquired the second acquisition quantity of second electronic money. Therefore, the first user U1 can use the second electronic money registered in the second electronic money management server in the name of the management user UX by executing the predetermined application software in the information terminal 2.

Thus, the ability to easily exchange the electronic money owned by the user U for other types of electronic money is suitable when the user U goes to a region or a store where his/her electronic money cannot be used. The user U may exchange electronic money at the time when the user U goes to the region or the store, or may exchange electronic money before he/she goes to the region or the store.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. An electronic money exchange apparatus comprising:
a storage unit that stores electronic money information for identifying electronic money available for each of a plurality of users;
an information acquisition unit that acquires exchange conditions from an information terminal which is used by a first user who desires to exchange first electronic money for second electronic money;
an exchange quantity determination unit that determines, on the basis of the exchange conditions and the electronic money information, a first release quantity which is the quantity of first electronic money the first user exchanges for the second electronic money and a second acquisition quantity which is the quantity of second electronic money acquired by the first user from among the second electronic money available for a second user, who is someone other than the first user; and
an exchange processing unit that executes an exchange process in which the second acquisition quantity of second electronic money is stored in the storage unit as usable electronic money in association with the first user, and the first release quantity of first electronic money is stored in the storage unit as the usable electronic money in association with a user who is different from the first user and has acquired the first electronic money released by the first user.

2. The electronic money exchange apparatus according to claim 1, further comprising
a notification unit that notifies a first electronic money management server managing the first electronic money that the first user used the first release quantity of first electronic money and that a predetermined management user has acquired the first release quantity of first electronic money.

3. The electronic money exchange apparatus according to claim 2, wherein the notification unit notifies a second electronic money management server managing the second electronic money that the second user who owned the second electronic money used the second acquisition quantity of second electronic money and that the management user has acquired the second acquisition quantity of second electronic money.

4. The electronic money exchange apparatus according to claim 2, wherein the notification unit notifies the first electronic money management server that the first user used the first release quantity of first electronic money, on a condition that the first electronic money is exchangeable for the second electronic money.

5. The electronic money exchange apparatus according to claim 2, wherein the notification unit notifies the first electronic money management server managing the first electronic money that the first user used the first release quantity of first electronic money, on a condition that the second acquisition quantity or more of exchangeable second electronic money is stored in the storage unit.

6. The electronic money exchange apparatus according to claim 2, wherein the notification unit notifies the first electronic money management server, the second electronic money management server, and a third electronic money management server, which respectively manage the first electronic money, the second electronic money, and third electronic money, that the first electronic money, the second electronic money, and the third electronic money owned by three or more of the users have been used, on a condition that an exchange of the first electronic money, the second electronic money, and the third electronic money has been established among the three or more users.

7. The electronic money exchange apparatus according to claim 1, wherein the storage unit stores the electronic money information including information indicating whether electronic money owned by each of a plurality of users can be exchanged for other electronic money, and
the exchange processing unit executes the exchange process on a condition that the second electronic money, which the electronic money information indicates as exchangeable among the second electronic money available for the second user, is equal to or more than the second acquisition quantity.

8. The electronic money exchange apparatus according to claim 1, wherein the information acquisition unit acquires a first range which is a range of exchange rates allowable by the first user when he/she exchanges the first electronic money for the second electronic money, and a second range which is a range of exchange rates allowable by the second user when he/she exchanges the second electronic money for the first electronic money, and the exchange quantity determination unit determines the second acquisition quantity on the basis of an exchange rate included in the first range and the second range.

9. The electronic money exchange apparatus according to claim 1, wherein the information acquisition unit acquires a minimum value of the exchange rate, which is a ratio of the second acquisition quantity to the first release quantity allowable by the first user when the first user exchanges the first electronic money for the second electronic money, and an exchange expiration date, which is an expiration date for when the first user exchanges the first electronic money for the second electronic money, and the exchange processing unit executes the exchange process on a condition that the second acquisition quantity is equal to or greater than the minimum value when there is a predetermined period or more before the exchange expiration date.

10. The electronic money exchange apparatus according to claim 1, wherein the storage unit stores the electronic money information including expiration date information indicating an expiration date of the electronic money, and
the exchange quantity determination unit determines the second acquisition quantity on the basis of a length of a period up to the expiration date.

11. The electronic money exchange apparatus according to claim 1, wherein the storage unit further stores history information indicating a history of the first user's acquisition of electronic money, and
the exchange processing unit stores the second acquisition quantity of second electronic money as usable electronic money in the storage unit in association with the first user when the exchange processing unit determines that the first electronic money corresponding to the second acquisition quantity can be acquired within a predetermined history confirmation period on the basis of the history information, even when the first user does not own the first electronic money corresponding to the second acquisition quantity.

12. The electronic money exchange apparatus according to claim 1, wherein the exchange processing unit stores the quantity of first electronic money acquired by the users in the storage unit in association with the users when the exchange processing unit receives a notification, from an electronic money management server that manages a balance of the first electronic money, that the users have acquired the first electronic money.

13. An electronic money exchange method comprising:
acquiring an exchange condition from an information terminal which is used by a first user who desires to exchange first electronic money for second electronic money;
determining, on the basis of electronic money information for identifying electronic money available for each of a plurality of users stored in a storage unit, a first release quantity which is the quantity of first electronic money the first user exchanges for the second electronic money and a second acquisition quantity which is the quantity of second electronic money acquired by the first user from among the second electronic money available for a second user, who is someone other than the first user;
storing the second acquisition quantity of second electronic money in the storage unit as usable electronic money in association with the first user; and
storing the first release quantity of first electronic money in the storage unit as the usable electronic money in association with a user who is different from the first user and has acquired the first electronic money released by the first user, that are executed by a computer.

14. An electronic money exchange system comprising:
an electronic money exchange apparatus that exchanges electronic money owned by a plurality of users; and
a plurality of information terminals used by the plurality of users, wherein the electronic money exchange apparatus includes:
a storage unit that stores electronic money information for identifying electronic money available for each of the plurality of users;
an information acquisition unit that acquires exchange conditions from one of the information terminals used by a first user who desires to exchange first electronic money for second electronic money; and
an exchange quantity determination unit that determines, on the basis of the exchange conditions and the electronic money information, a first release quantity which is the quantity of first electronic money the first user exchanges for the second electronic money and a second acquisition quantity which is the quantity of second electronic money acquired by the first user from among the second electronic money available for a second user, who is someone other than the first user; and
an exchange processing unit that executes an exchange process in which the second acquisition quantity of second electronic money is stored in the storage unit as usable electronic money in association with the first user, and the first release quantity of first electronic money is stored in the storage unit as the usable electronic money in association with a user who is different from the first user and has acquired the first electronic money released by the first user, and
the information terminal of the first user includes:
a receiving unit that receives a notification that the exchange process is completed; and
a transmitting unit that transmits to the electronic money exchange apparatus an indication that the second electronic money is used when the first user uses the second electronic money.

15. The electronic money exchange system according to claim 14, wherein the information terminal of the first user further includes:
a usage processing unit that transmits information for using the second electronic money in an account name of a predetermined management user when using the second electronic money.
